(19) United States
(12) Patent Application Publication
(10) Pub. No.: US 2009/0211094 A1
(43) Pub. Date: Aug. 27, 2009

(54) METHOD AND APPARATUS FOR INSTALLING NITINOL PLUG

(76) Inventor: Roger Adelman, Villa Hills, KY (US)

Correspondence Address: WOOD, HERRON & EVANS, LLP, 2700 CAREW TOWER, 441 VINE STREET, CINCINNATI, OH, 45202, US

(21) Appl. No.: 12/037,704

(22) Filed: Feb. 26, 2008

(51) Int. Cl. B23P 11/02; B25B 27/14; C22C 19/00; C22C 14/00

(52) U.S. Cl. 29/890.031; 29/402.09; 29/402.12; 29/259; 205/640; 420/446

(57) ABSTRACT

A memory metal or Nitinol plug is inserted into a tube and heated to cause the plug to expand as it transforms from a martensitic state to an austenitic state. The plug is held by a tool connected to an electric conductor. The tube is then grounded and current is run through the holder, the plug, and, in turn, the tube. Electrical resistance causes the plug to heat up and revert to the austenitic state. The holder is preferably a tube with an internal collet, spring urged into a closed position adapted to grasp a post of the Nitinol plug. To separate the holder from the plug, the collet is pulled to an expanded position by pulling the holder from the tube. This allows the collet to open and separate from the plug.

### BACKGROUND OF THE INVENTION

Heat exchangers are used in a variety of applications such as power plants, steam engines, and the like. These heat exchangers include a series of tubes that transfer heat exchange fluid. The individual tubes can begin to leak, and may need to be plugged in order to prevent further damage to the heat exchanger.

There are a wide variety of different methods used to plug leaking tubes. In certain applications, explosive devices are used to expand a plug in the tube to seal it off. But, this is very expensive. Mechanical devices can also be used. But, under repeated thermal cycling, these may fail due to different rates of thermal expansion.

Hall U.S. Pat. No. 5,189,789 discloses the use of a memory metal or Nitinol plug. Memory metals are alloys that undergo a reversible transformation from an austenitic state to a martensitic state with changes in temperatures. At colder temperatures, the alloy enters the martensitic state and reverts to the austenitic state at higher temperatures. A plug in the martensitic state can be bent or shaped. When the metal reverts to the austenitic state, it reverts to its original shape.

The plug disclosed in Hall U.S. Pat. No. 5,189,789 is formed from such a memory metal and includes a central post with a plurality of disks that extend perpendicular to the post. The disclosed plug is placed in a bath of methanol and dry ice to cause it to enter the martensitic state. It is then forced through a die, which bends or swages the disks, decreasing the exterior diameter of the plug. The plug can then be manually placed into a tube and heated, causing it to revert to the austenitic state at which point in time the disks will bend back to their original shape, increasing the diameter of the plug, thus plugging the tube.

An improved plug is disclosed in pending U.S. Application Ser. No. 11/396,739, entitled “Memory Metal Plug”, filed on Apr. 3, 2006, and published Jun. 7, 2007, the disclosure of which is hereby incorporated by reference. As with the plug disclosed in the Hall reference, this plug is deformed or swaged while in the martensitic sate. Thus, its diameter is decreased. The improved memory metal plug is installed by placing the swaged plug in a tube, preferably with a heat conducting holder, such as a stainless steel holder. The plug and holder are then heated, for example, with a blowtorch, which causes the plug to change from its swaged martensitic state and revert to the austenitic state increasing its diameter and sealing the tube.

When heat is applied from the one end, it will cause at least the disk or wing closest to the heating source to revert to the austenitic state. The disks farther from the heat source may not be heated and thus may remain in the martensitic state. Thus, they would not provide any sealing. Heat from the heat exchanger should eventually cause the remaining disks to revert to the austenitic state, which would insure that the tube remains sealed. However, with this method, there may be a short period of time in which the plug does not reach its strongest possible seal strength. This presents short term issues that must be addressed.

### SUMMARY OF THE INVENTION

The present invention is premised on the realization that a memory metal or Nitinol plug can be inserted into a tube to seal the tube by positioning the plug in the tube with a holder which acts to heat the plug. The holder is connected to a current source once the plug is in position. The tubes are grounded so that the current flows through the holder and the plug to the tubes. Electrical resistance heats the Nitinol plug. The leading disk may have a slightly larger diameter than the trailing disks to ensure that current flows through the leading disk. This ensures that the entire memory metal plug is heated sufficiently to cause the entire plug to revert to the austenitic state and, thus, reach its maximum sealing capabilities immediately. Thus, if the heat exchanger is put back into operation and an extreme amount of pressure is initially incurred, the plug will remain in place.

Further, because the energy is supplied by a flexible cable, the plug can be inserted a relatively long distance into the tube and can even be inserted into a curved tube. Pulling back on the cable will release the expanded plug from the holder anywhere in the tube.

The objects and advantages of the present invention will be further appreciated in light of the following detailed description and drawings in which:

### BRIEF DESCRIPTION OF THE DRAWING

FIG. 1 is a diagrammatic depiction of a plug being inserted into a heat exchange tube;

FIG. 2 is an exploded view of the heated holder of the present invention;

FIG. 3A is a cross sectional view of the holder of the present invention grasping a memory metal plug in the martensitic state; and

FIG. 3B is the same view as 3A with the plug in the austenitic state.

### DETAILED DESCRIPTION

The present invention utilizes a holder 10 designed to hold a memory metal plug 12 and insert the plug into a tube 14 of a heat exchanger 16.

The plug 12 includes a central shaft 18 and a plurality of disks 20 (20a, 20b, 20c, shown), as well as an outermost post 22. The peripheral edge 24 of each of the disks is intended to be slightly larger than the internal diameter of tube 14, as will be explained later in discussing the insertion of the plug into the tube.

Although the diameter of each disk may be the same diameter, the leading disk 20a may be slightly larger (i.e., about 0.003 in) than the trailing disks 20b and 20c, as discussed below.

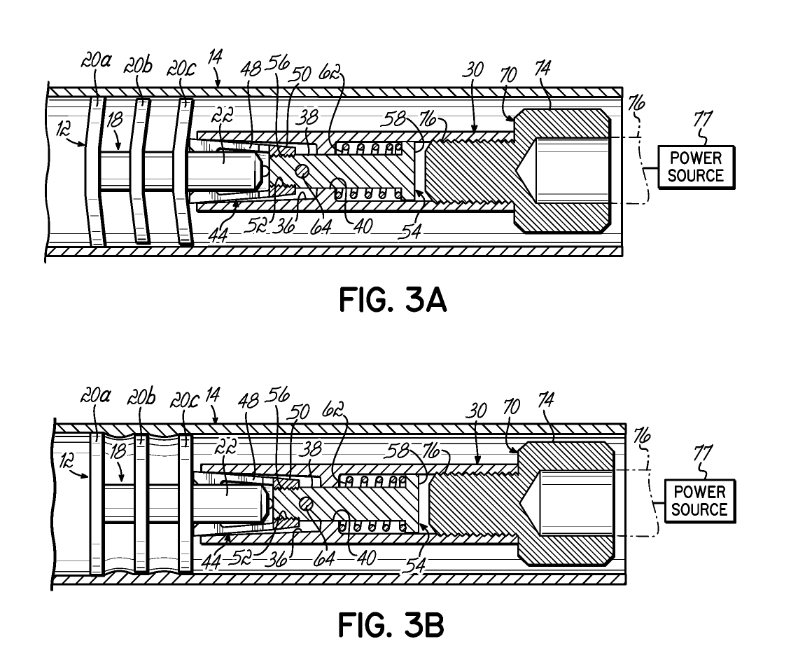

The holder 10 includes a tube or case 30, having an internally threaded proximal end 32, and a distal end 34. The distal end 34 includes an inner portion 36, which is tapered as shown in FIGS. 3A and 3B. Located within the tube 30 is an annular ledge 38, having a central opening 40. The sidewall 41 of tube 30 includes opposed oblong ports 43.

A collet 44 is located at the distal end 34 of the tube 30. The collet 44 includes a tapered outer surface 46, and includes a plurality of channels 47 which run partially along the collet 44. The channels 47 divide the collet 44 into a plurality of flared segments 48, which connect to a solid annular portion 50. The solid annular portion 50 has an internally threaded opening 52, which is adapted to receive the externally threaded end 56 of rod 54. Opposite end 56 of rod 54 is an enlarged head 58 which has a diameter slightly less than the diameter of the inner surface 60 of tube 30. A spring 62 is positioned between the annular ledge 38 and the head 58. Spring 62 applies pressure pulling the collet 44 in towards the annular ledge 38. A pin 64 extends through the oblong ports 43 and through rod 54.

The holder 10 is completed with a connector 70, which includes an externally threaded end 72, which is threaded into the internally threaded end 32 of tube 30. Connector 70 includes a hexagonal head portion 74. An insulated wire 76, which, as shown in FIGS. 3A and 3B, connects to a power source 77, is connected to head portion 74.

Once assembled, the tool acts to pull the collet 44 into the tube 30. More particularly, the rod 54 is urged toward the connector 70 by spring 62. This in turn pulls the collet 44 in the same direction. Because the collet 44 has a tapered outer surface 46, and the tube 30 has a tapered inner surface 36, the segments 48 are compressed, decreasing the size of opening 78 in collet 44.

The entire holder is preferably formed from an electrically-conductive metal, such as aluminum, steel, or the like. Stainless steel is preferred. The exterior of the holder 10 may be coated, or otherwise formed or surrounded, with an insulating material such as polyurethane, or the like.

The holder 10 is used to grasp the post 22 of plug 12 and insert plug 12 into a tube 14 of heat exchanger 16. More particularly, the plug 12 will be in a swaged martensitic state, represented by the plug 12 in FIG. 3A. Because the disks 20 are bent backwardly, the diameter of the plug 12 is reduced.

Holder 10 is attached to post 22, by moving collet 44 outwardly from tube 30 by grasping the ends of pin 64 and by moving pin 64 forwardly. This moves rod 54 forwardly, allowing the segments 48 of collet 44 to spring outwardly, expanding opening 78 to a size which will allow post 22 to be inserted.

Releasing the ends of pin 64 allows the spring 62 to pull the rod 54 and the collet 44 back into tube 30, applying pressure against post 22. This holds the plug 12 attached to holder 10.

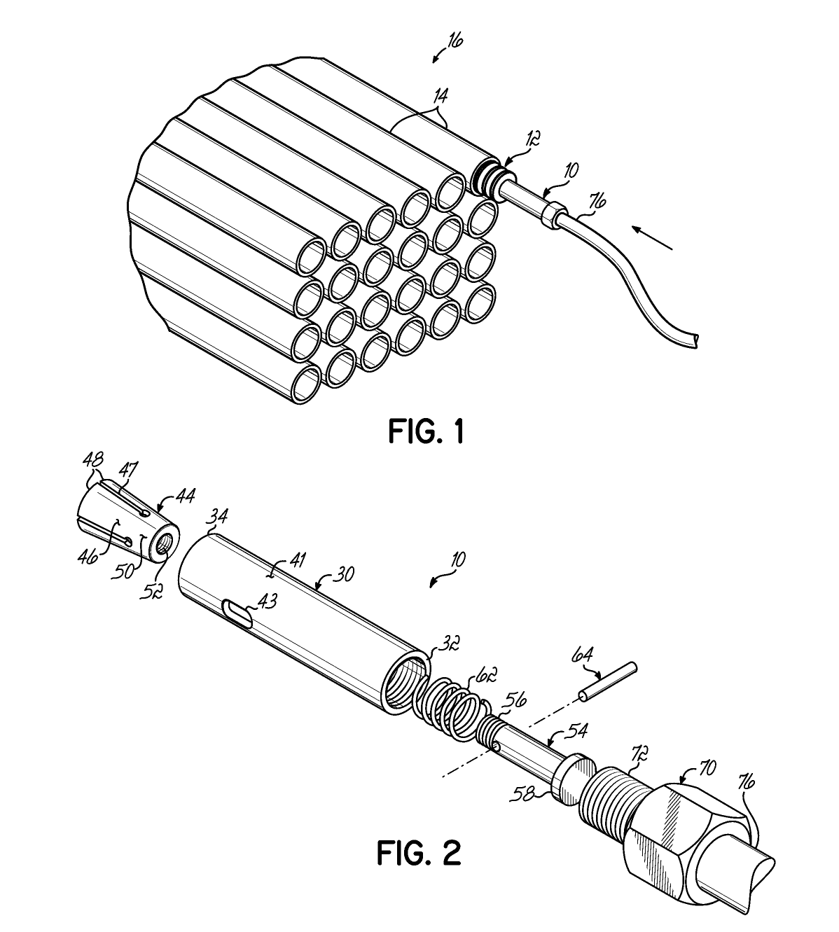

The plug 12 and tool 10 are then inserted into a tube 14 as shown diagrammatically in FIG. 1. The plug 20 has a greater diameter than the holder 10. Therefore, the holder should not contact the walls of tube 14. As previously discussed, the holder can be insulated to further ensure that it does not short out. Once the plug is inside the tube 14, electric current is applied through conductor 76 through tool 10 to the Nitinol plug 12. The tube 14 in turn is grounded, allowing current to flow through the Nitinol plug 12 and through the tube. The resistance of the current through the Nitinol plug 12 will generate heat in the Nitinol plug 12. If the lead disk 20a has a greater diameter than the rear disks, 20b and 20c, lead disk 20a will be in physical contact with the interior surface of the tube. Thus, the initial current flow will be through lead disk 20a. Current flow is continued until all of the disks reach the austenitic stage. Generally, application of 175 amps of current at a nominal 30 volts for a period of 30 seconds ensures that the plug reaches a temperature of at least about 400° F., which will ensure that all disks of the plug are in the austenitic state. This can be accomplished with a stick welder such as a Lincoln Model S 225.

Once the plug is installed, the holder 10 is simply pulled from the tube 14. Initially, the force of the collet 44 against the post 22 will prevent the holder 10 from separating from the inserted plug 12. However, upon applying additional force, the tube 30 is pulled away from collet 44, allowing the segments 48 to expand outwardly, releasing the post 22, and allowing the holder 10 to be removed from the tube 14.

This device enables one to insert a Nitinol plug a relatively long distance within a tube and, further, can be used with a tube that is not linear.

This has been a description of the present invention along with the preferred method of practicing the present invention. However, the present invention should only be defined by the appended claims, WHEREIN WE CLAIM:

What is claimed is:

1. A method of inserting a memory metal plug into a tube comprising
grasping said plug with a holder, said plug being in a swaged martensitic state;
inserting said holder and said plug into said tube; and
applying electrical current through said holder and through said plug to thereby heat said plug and convert said plug to an austenitic state.

2. The method claimed in claim 1 wherein said plug includes a series of disks connected by a central shaft and a post wherein said post is positioned in said holder.

3. The method claimed in claim 2 wherein said plug has a leading disk and at least one trailing disk between said leading disk and said post, and wherein said leading disk has a diameter greater than the diameter of said trailing disk.

4. A holder for inserting a memory metal plug into a tube;
a grasping apparatus adapted to grasp said plug; and
an electrical conductor fixed to said holder wherein said holder provides an electrical path from said conductor to said grasping apparatus.

5. The apparatus claimed in claim 4 wherein said grasping apparatus comprises a collet.

6. The apparatus claimed in claim 4 wherein said collet is spring urged into a closed position.

7. The holder claimed in claim 5 wherein said holder has an outer insulating surface.

8. The holder claimed in claim 6 further comprising a means to manually move said collet to an open position.

9. A memory metal plug having at least a first and second disk attached to a central shaft wherein said first disk has a diameter larger than said second disk.
